(19) United States
(12) Patent Application Publication
(10) Pub. No.: US 2015/0381279 A1
(43) Pub. Date: Dec. 31, 2015

(54) OPTICAL TRANSCEIVER AND COMMUNICATION SYSTEM

(71) Applicants: The University of Tokyo, Tokyo (JP); Oclaro Japan, Inc., Kanagawa (JP)

(72) Inventors: Takuo TANEMURA, Tokyo (JP); Yoshiaki NAKANO, Tokyo (JP); Takayoshi FUKUI, Yokohama (JP); Masaru MUKAIKUBO, Tokyo (JP); Shunya YAMAUCHI, Sagamihara (JP)

(21) Appl. No.: 14/748,890

(22) Filed: Jun. 24, 2015

(30) Foreign Application Priority Data
Jun. 25, 2014 (JP) 2014-130576
May 14, 2015 (JP) 2015-099033

(51) Int. Cl. H04B 10/40; H04J 14/02; H04J 14/06

(52) U.S. Cl. CPC H04B 10/40; H04J 14/06; H04J 14/0221

(57) ABSTRACT

A communication system includes a termination-side optical transmitter comprising a reflective semiconductor optical amplifier, a reflective unit configured to reflect output light from the termination-side optical transmitter, and a terminal station-side optical receiver connected to the termination-side optical transmitter via a transmission line and configured to receive the output light from the termination-side optical transmitter by limiting a frequency band of the output light. The reflective semiconductor optical amplifier amplifies the output light reflected by the reflective unit, modulates the amplified output light based on an electric signal, and outputs the modulated output light.

### CROSS-REFERENCE TO RELATED APPLICATION

The present application claims priority from Japanese applications JP 2014-130576 and JP 2015-099033, the content of which is hereby incorporated by reference into this application.

### BACKGROUND OF THE INVENTION

1. Field of the Invention

The present invention relates to an optical transceiver and a communication system.

2. Description of the Related Art

An optical transceiver and a communication system that use a reflective semiconductor optical amplifier as a light source are disclosed in: E. Wong, et al., JLT vol. 25, No. 1, p. 67, 2007; M. Presi and E. Ciaramella, OFC2011, OMP4; and S. O'Duill, et al., ECOC2012, We.2.E.1.

Proposed in E. Wong, et al., JLT vol. 25, No. 1, p. 67, 2007 is use of a semiconductor optical amplifier free from polarization dependency as a unit for canceling polarization dependency of an optical transceiver in a practical system in a field.

In M. Presi and E. Ciaramella, OFC2011, OMP4, as a method of reducing an influence of polarization dependency on a system when an optical transceiver is formed by using a semiconductor optical amplifier having polarization dependency as the light source, there is proposed an optical wavelength multiplex communication system that effectively eliminates the influence of the polarization dependency by using rotation and reflection of a polarization in combination of a Faraday rotator and a mirror.

S. O'Duill, et al., ECOC2012, We.2.E.1, discloses an example in which a modulation cancellation dynamic range (MCDR) is approximately 13 dB, which is one of features provided to a reflective semiconductor optical amplifier.

### SUMMARY OF THE INVENTION

Here, as a problem other than the polarization dependency described above, it is reported in E. Wong, et al., JLT vol. 25, No. 1, p. 67, 2007 that a frequency characteristic of signal light to be output exhibits a high-pass characteristic due to gain saturation of the reflective semiconductor optical amplifier used as the light source. The inventors of the present invention have found that such a high-pass characteristic also exhibits the same characteristic in relative intensity noise spectrum of the signal light, which may cause deterioration in an S/N ratio of the optically modulated signal light to occur in a high frequency band thereof.

Further, in the reflective semiconductor optical amplifier, high speed modulation and a high MCDR characteristic may become hard to realize when a current is injected by one electrode.

In view of the above-mentioned problems, an object of one or more embodiments of the present invention is, for example, to realize at least one of an optical wavelength multiplex communication system further improved in an S/N ratio of signal light while securing a desired MCDR or an optical wavelength multiplex communication system capable of higher speed modulation while securing a desired MCDR.

(1) In one or more embodiments of the present invention, a communication system includes a termination-side optical transmitter comprising a reflective semiconductor optical amplifier, a reflective unit configured to reflect output light from the termination-side optical transmitter, and a terminal station-side optical receiver connected to the termination-side optical transmitter via a transmission line and configured to receive the output light from the termination-side optical transmitter by limiting a frequency band of the output light. The reflective semiconductor optical amplifier amplifies the output light reflected by the reflective unit, modulates the amplified output light based on an electric signal, and outputs the modulated output light.

(2) In the communication system according to (1), the terminal station-side optical receiver receives the output light from the termination-side optical transmitter by limiting the frequency band of the output light based on a frequency characteristic of a relative intensity noise of the output light.

(3) In one or more embodiments of the present invention, a communication system includes a termination-side optical transmitter comprising a reflective semiconductor optical amplifier and a pre-emphasis unit configured to increase a modulation degree of a transmission signal, a reflective unit configured to reflect output light from the termination-side optical transmitter, and a terminal station-side optical receiver connected to the termination-side optical transmitter via a transmission line. The reflective semiconductor optical amplifier amplifies the output light reflected by the reflective unit, modulates the amplified output light based on an electric signal having the increased modulation degree, and outputs the modulated output light.

(4) In the communication system according to (3), the pre-emphasis unit increases the modulation degree based on a frequency characteristic of a relative intensity noise of the output light.

(5) In the communication system according to (4), the terminal station-side optical receiver receives the output light from the termination-side optical transmitter by limiting a frequency band of the output light.

(6) In the communication system according to (5), the terminal station-side optical receiver receives the output light from the termination-side optical transmitter by limiting the frequency band of the output light based on an increase in the modulation degree caused by the pre-emphasis unit.

(7) In the communication system according to one of (3) to (6), the pre-emphasis unit increases the modulation degree within a modulation frequency range up to approximately 1/2 of a transmission rate.

(8) In one or more embodiments of the present invention, a communication system includes a termination-side optical transmitter comprising a reflective semiconductor optical amplifier, a reflective unit configured to reflect output light from the termination-side optical transmitter, and a terminal station-side optical receiver connected to the termination-side optical transmitter via a transmission line and configured to receive the output light from the termination-side optical transmitter. The reflective semiconductor optical amplifier amplifies the output light reflected by the reflective unit, modulates the amplified output light based on an electric signal, and outputs the modulated output light. An amplifier length of the reflective semiconductor optical amplifier is from 500 μm to 2,000 μm.

(9) In the communication system according to (8), a current injected into the reflective semiconductor optical amplifier is from 100 mA to 300 mA.

(10) In the communication system according to (9), the reflective semiconductor optical amplifier includes a first electrode and a second electrode. The first electrode and the second electrode are different from each other in length, and are configured to inject the current independently.

(11) In the communication system according to (10), the length of the second electrode in a direction along the output light is shorter than the length of the first electrode. The current for modulating the output light based on the electric signal is injected into the second electrode.

(12) In the communication system according to one of (1) to (11), the termination-side optical transmitter further includes a delay attenuation unit configured to delay the electric signal based on a delay time of the output light returned to the reflective semiconductor optical amplifier after being reflected by the reflective unit and configured to invert a polarity of the electric signal. The reflective semiconductor optical amplifier further modulates the output light based on a signal output from the delay attenuation unit, and outputs the modulated output light.

(13) In the communication system according to claim one of (1) to (12), the communication system further includes a plurality of termination devices each comprising the termination-side optical transmitter. The respective termination-side optical transmitters included in the plurality of termination devices are different from one another in wavelength of the output light.

(14) In the communication system according to one of (1) to (13), the communication system further includes a terminal station including a plurality of the terminal station-side optical receivers and a plurality of terminal station-side optical transmitters. The plurality of terminal station-side optical transmitters respectively output the output light having different wavelengths from one another.

(15) In one or more embodiments of the present invention, an optical transceiver includes the termination-side optical transmitter of one of (1)-(14) and a termination-side optical receiver.

(16) In one or more embodiments of the present invention, an optical transceiver includes the terminal station-side optical receiver of one of (1)-(14) and a terminal station-side optical transmitter.

(17) In the optical transceiver according to (16), the reflective unit is included in the optical transceiver.

(18) In the optical transceiver according to (17), the reflective unit within the optical transceiver includes an optical amplifier and a polarization rotation/reflection unit.

(19) In the optical transceiver according to (17), the reflective unit within the optical transceiver includes a reflective semiconductor optical amplifier.

### BRIEF DESCRIPTION OF THE DRAWINGS

FIG. 1 is a diagram for illustrating an outline of a configuration of an optical transceiver included in a termination device according to a first embodiment of the present invention.

FIG. 2 is a diagram for illustrating an outline of a configuration of an optical wavelength multiplex communication system according to the first embodiment.

FIG. 3 is a graph for showing an example of a spontaneous emission spectrum caused to occur by current injection into a reflective semiconductor optical amplifier according to the first embodiment.

FIG. 4 is a graph for showing an example of an optical spectrum of a given specific channel of optically amplified light according to the first embodiment.

FIG. 5 is a graph for showing an example of a relative intensity noise spectrum of signal light output from the reflective semiconductor optical amplifier and a reception characteristic of a terminal station-side optical receiver whose band is corrected, according to the first embodiment.

FIG. 6 is a diagram for illustrating an example of a configuration of the terminal station-side optical receiver according to the first embodiment.

FIG. 7 is a graph for showing an outline of a second embodiment of the present invention.

FIG. 8 is a diagram for illustrating an example of a configuration of a termination-side optical transmitter according to the second embodiment of the present invention.

FIG. 9 is a diagram for illustrating an example of a configuration of a termination-side optical transmitter according to a third embodiment of the present invention.

FIG. 10A and FIG. 10B are graphs for showing an input-output characteristic of a reflective semiconductor optical amplifier according to a fourth embodiment of the present invention.

FIG. 11A and FIG. 11B are graphs for showing amplifier length dependency of a MCDR and a gain of the reflective semiconductor optical amplifier according to the fourth embodiment of the present invention.

FIG. 12 is a diagram for illustrating a reflective semiconductor optical amplifier according to a fifth embodiment of the present invention.

FIG. 13 is a diagram for illustrating an outline of a configuration of an optical wavelength multiplex communication system according to a sixth embodiment of the present invention.

FIG. 14 is a diagram for illustrating an example of a configuration of a terminal station-side optical transceiver 1001 illustrated in FIG. 13.

FIG. 15 is a diagram for illustrating an outline of a configuration of a terminal station-side optical transceiver 1003 according to a modification example of the sixth embodiment of the present invention.

FIG. 16 is a diagram for illustrating a modification example of the present invention.

### DETAILED DESCRIPTION OF THE INVENTION

Referring to the accompanying drawings, embodiments of the present invention are described below. In the drawings, the same or similar components are denoted by the same reference symbols, and a repetitive description thereof is omitted.

### First Embodiment

Now, a configuration of an optical transceiver including an optical transmitter that uses a reflective semiconductor optical amplifier as a light source and an optical receiver for receiving signal light, and a configuration of an optical wavelength multiplex communication system using the same, according to a first embodiment of the present invention, are described with reference to the accompanying drawings.

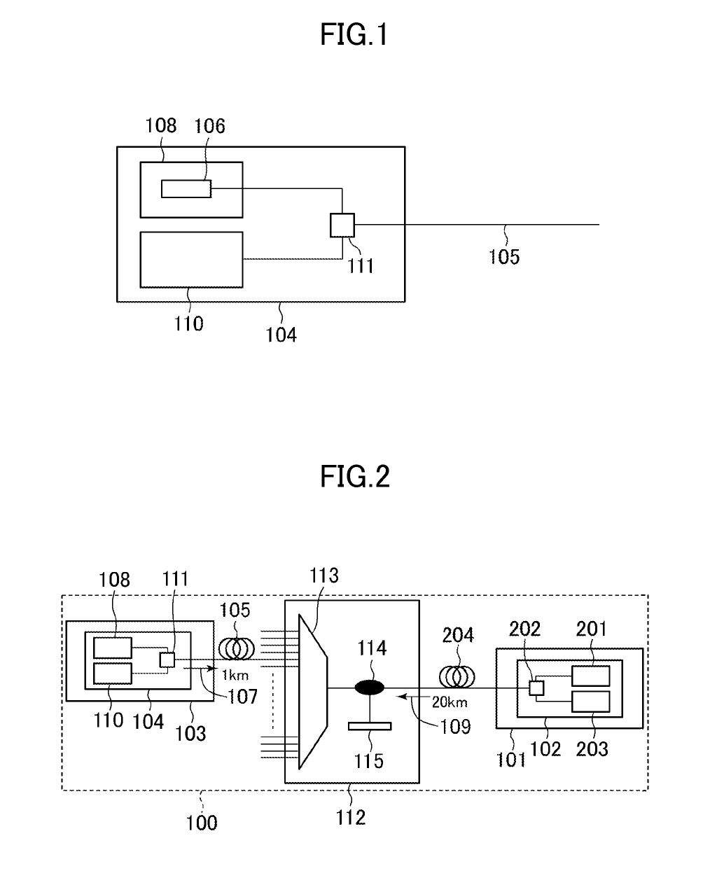

FIG. 1 is a diagram for illustrating an outline of the configuration of an optical transceiver included in a termination device according to the first embodiment of the present invention. FIG. 2 is a diagram for illustrating an outline of a configuration of the optical wavelength multiplex communication system according to this embodiment. Note that, the outlines of the configurations illustrated in FIG. 1 and FIG. 2 are merely examples, and this embodiment is not limited to the configurations illustrated in FIG. 1 and FIG. 2.

As illustrated in FIG. 1 and FIG. 2, an optical wavelength multiplex communication system 100 according to this embodiment mainly includes a terminal station 101, a remote node 112, and a termination device 103. The terminal station 101 and the remote node 112 are connected to each other by an optical fiber 204, and the remote node 112 and the termination device 103 are connected to each other by an optical fiber 105.

A termination-side optical transceiver 104 included in the termination device 103 includes a termination-side optical transmitter 108, a termination-side optical receiver 110, and a WDM filter 111. The termination-side optical transmitter 108 sets output light from a reflective semiconductor optical amplifier 106 as a light source of the signal light, and transmits an incoming signal 107. On the other hand, the termination-side optical receiver 110 receives an outgoing signal 109 having a specific wavelength, which is transmitted from the terminal station 101. Further, the incoming signal 107 and the outgoing signal 109 are branched off by the WDM filter 111. Note that, an optical circulator may be used in place of the WDM filter 111.

Note that, in this embodiment, for example, the reflective semiconductor optical amplifier 106 having a polarization gain difference of approximately 3 dB is used as the light source. An active (amplification) layer of the reflective semiconductor optical amplifier 106 may be a multiple quantum well structure, or may be a bulk structure. Further, the reflective semiconductor optical amplifier 106 is formed of, for example, an InGaAsP-based material known as a general group III-V compound semiconductor material. Note that, the reflective semiconductor optical amplifier 106 may be formed of an InAlGaAs-based material.

As described above, in the optical wavelength multiplex communication system 100, the remote node 112 is connected to a transmission line between the termination device 103 and the terminal station 101 in order to increase the number of connected termination devices 103 and to extend a transmission distance of the termination device 103. The remote node 112 includes an optical multiplexer/demultiplexer 113, an optical branch coupler 114, and a polarization rotation/reflection unit 115. The optical multiplexer/demultiplexer 113 demultiplexes the outgoing signal 109 from the terminal station 101 into a plurality of respective termination devices 103. The optical branch coupler 114 branches the output light from the reflective semiconductor optical amplifier 106. The polarization rotation/reflection unit 115 rotates and reflects a polarization plane of the output light branched by the optical branch coupler 114, and returns the output light to the termination device 103.

Further, as illustrated in FIG. 2, a terminal station-side optical transceiver 102 included in the terminal station 101 includes a terminal station-side optical transmitter 201, a terminal station-side optical receiver 203, and a WDM filter 202. The terminal station-side optical transmitter 201 generates the outgoing signal 109, and is formed of, for example, a wavelength variable light source or a direct modulation semiconductor laser. The terminal station-side optical receiver 203 receives the incoming signal 107 transmitted from the termination device 103. The WDM filter 202 is connected in order to branch the incoming signal 107 and the outgoing signal 109, and may be replaced by an optical circulator.

Next, a description is made of an operation principle of the optical wavelength multiplex communication system 100 according to this embodiment.

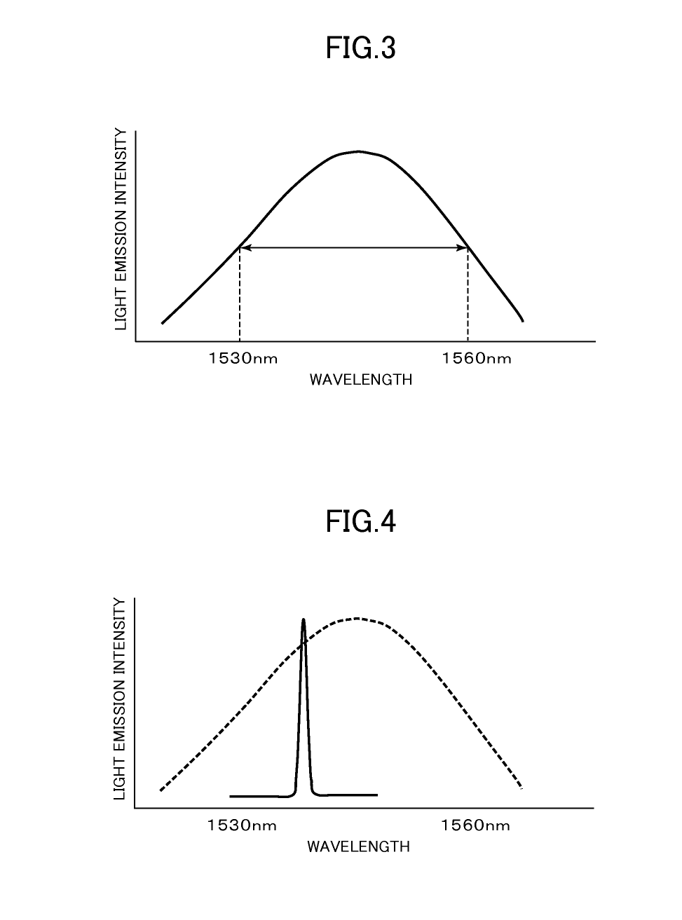

The spontaneous emission light occurs when a current is injected into the reflective semiconductor optical amplifier 106. For example, as shown in FIG. 3, the spontaneous emission light that has occurred is a broad emission spectrum in which the wavelength of a full width at half maximum covers a range from approximately 1,530 nm to approximately 1,560 nm. The spontaneous emission light output from a front end face of the reflective semiconductor optical amplifier 106 is demultiplexed into a plurality of respective wavelengths when, for example, passing through the optical multiplexer/demultiplexer 113 included in the remote node 112 installed distant from the termination device 103 by approximately 1 km. Note that, for example, as the optical multiplexer/demultiplexer 113, a case in which the spontaneous emission light is multiplexed/demultiplexed into 4 to 8 channels by use of a multilayer filter is used or a method of multiplexing/demultiplexing the spontaneous emission light into 32 channels of wavelength multiplexing at an interval of a frequency of 100 GHz (wavelength interval of 0.8 nm) by use of an array type waveguide is used.

The light demultiplexed into the wavelength of a given specific channel is guided to the polarization rotation/reflection unit 115 via the optical branch coupler 114. Then, the polarization rotation/reflection unit 115 rotates and reflects a polarization. The reflected light returns to the termination device 103 via the optical multiplexer/demultiplexer 113, and is input to the same front end face from which the output light from the reflective semiconductor optical amplifier 106 has been emitted. The light input to the reflective semiconductor optical amplifier 106 progresses within the reflective semiconductor optical amplifier 106 toward a back end face thereof while being optically amplified, is reflected by the back end face, moves back toward the front end face while being optically amplified, and is again output from the front end face as the output light.

After the polarization is rotated and reflected by the polarization rotation/reflection unit 115 again via the optical multiplexer/demultiplexer 113 and the optical branch coupler 114, the light output from the front end face of the reflective semiconductor optical amplifier 106 is again input to the front end face of the reflective semiconductor optical amplifier 106 of the termination device 103 through the optical multiplexer/demultiplexer 113.

By repeating the reflection and the amplification of the output light from the reflective semiconductor optical amplifier 106 between the termination device 103 and the remote node 112 in the above-mentioned manner, the output light including an optical spectrum of such a given specific channel (specific wavelength) as shown in FIG. 4 is generated from such a spontaneous emission spectrum that has occurred in the reflective semiconductor optical amplifier 106 as shown in FIG. 3. In this state, by superposing a modulated current corresponding to a transmission signal onto the reflective semiconductor optical amplifier 106, a signal light having a “1 (on)” level and a “0 (off)” level is generated, and the generated signal light is transmitted from the termination device 103 to the terminal station 101 as the incoming signal 107.

Note that, the reflective semiconductor optical amplifier 106 in which the spontaneous emission light is 1,550-nm band is described above, but the reflective semiconductor optical amplifier 106 using 1,300-nm band or other such band may be employed. Note that, the use of the InAlGaAs-based material is preferred to the use of the InGaAsP-based material from the viewpoint of characteristics in the case of the reflective semiconductor optical amplifier using the 1,300-nm band.

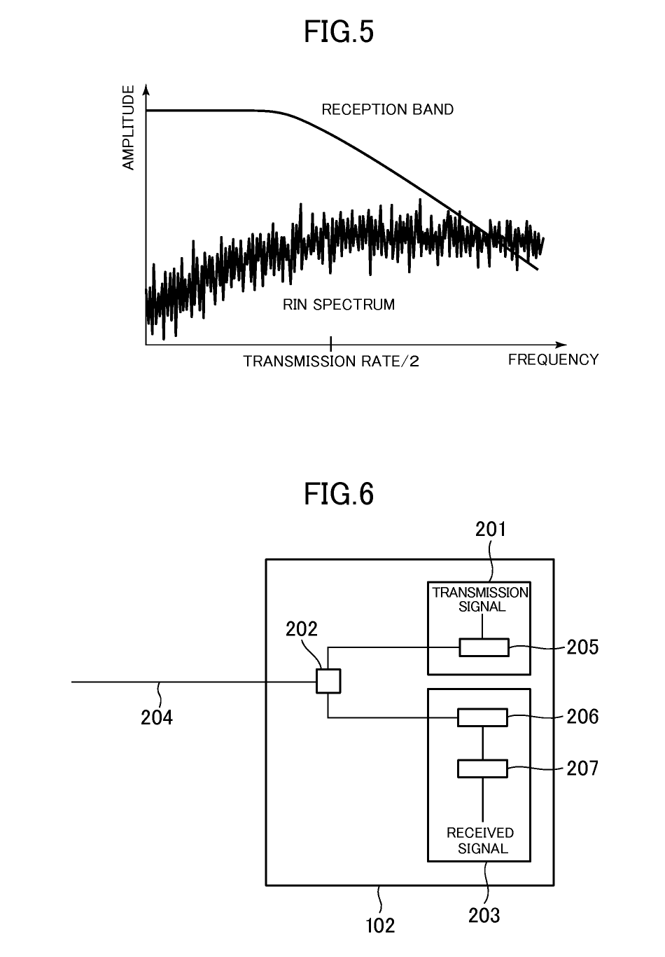

In this case, the signal light output from the reflective semiconductor optical amplifier 106 includes the relative intensity noise (RIN). The relative intensity noise is obtained by normalizing fluctuations in light intensity by mean optical power, and exhibits a substantially flat frequency characteristic in a signal band with a general laser light source. However, the inventors of the present invention have found that, for example, as shown in FIG. 5, the relative intensity noise (RIN) of the reflective semiconductor optical amplifier 106 exhibits such a high-pass characteristic as to increase as the frequency becomes higher. Such a high-pass characteristic causes deterioration in an S/N ratio of the signal light due to the influence of high frequency noise, which becomes a factor that influences waveform quality of an eye opening. Thus, it is important to compensate the influence for improvement.

Therefore, in this embodiment, the signal light in the terminal station-side optical receiver 203 of the terminal station 101 is provided with a reception band for limiting the reception in a frequency band equal to or wider than approximately ½ of a transmission rate such as indicated by, for example, the solid line in FIG. 5.

Specifically, for example, as illustrated in FIG. 6, the terminal station-side optical receiver 203 according to this embodiment includes, for example, the terminal station-side light receiver 206 and a reception band correction circuit 207 for correcting the reception band. The reception band correction circuit 207 allows the reception band of the signal, which is transmitted via the optical fiber 204 and acquired by the terminal station-side light receiver 206, to be limited so as to eliminate noise outside a transmission band. Note that, the reception band correction circuit 207 is formed of, for example, a filter. This can suppress the noise outside the transmission band included in the received signal in a high frequency band.

In this manner, in this embodiment, the terminal station-side optical receiver 203 of the terminal station 101 receives the signal light by limiting the frequency characteristic provided thereto when detecting input light that is output from the reflective semiconductor optical amplifier 106 and input to a terminal station-side optical receiver 203 of the terminal station 101. This can suppress the deterioration in the S/N ratio of the received signal in the terminal station 101 of the optical wavelength multiplex communication system 100.

According to this embodiment, it is possible to realize the optical wavelength multiplex communication system 100 or the like in which the S/N ratio of the signal light is improved.

### Second Embodiment

Next, a second embodiment of the present invention is described. Note that, descriptions of the same points as those of the first embodiment are omitted below.

In the same manner as the first embodiment, as shown in FIG. 5, the relative intensity noise (RIN) of the reflective semiconductor optical amplifier 106 exhibits such a high-pass characteristic as to increase as the frequency becomes higher. Then, the S/N ratio of the signal light optically modulated by the termination-side optical transmitter 108 deteriorates due to the influence of the high-pass characteristic exhibited by the relative intensity noise (RIN) of the signal light output from the reflective semiconductor optical amplifier 106.

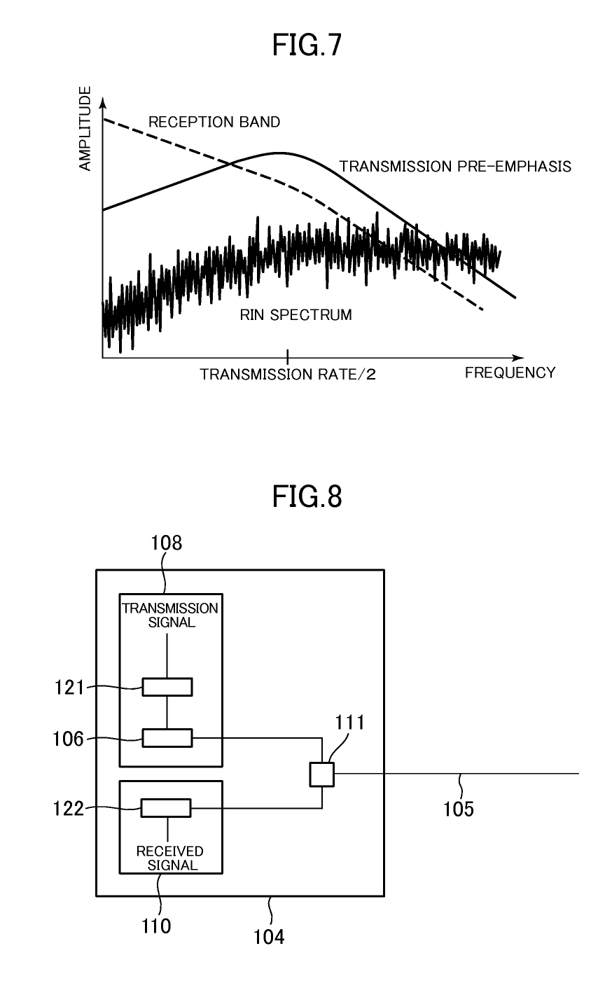

Therefore, as shown in FIG. 7, the termination-side optical transmitter 108 according to this embodiment conducts pre-emphasis processing for increasing a modulation degree as the frequency increases within a modulation frequency range up to approximately ½ of the transmission rate so as to match a modulation characteristic of the signal light with the frequency characteristic of the relative intensity noise (RIN). This can suppress the deterioration in the S/N ratio of the signal light also on the termination-side optical transmitter 108 side in the same manner as the terminal station-side optical receiver 203.

In addition, in this embodiment, a reception characteristic of the terminal station-side optical receiver 203 is set as such a reception characteristic as indicated by the broken line in FIG. 7 so that the relative intensity noise within a high frequency range is further attenuated to correct the frequency characteristic subjected to the pre-emphasis by the termination-side optical transmitter 108 to become flat within the band. This can greatly suppress the deterioration in the S/N ratio of the received signal, and can produce a transmission characteristic that is more satisfactory and more stable at a time of high speed modulation.

Specifically, in this embodiment, for example, as illustrated in FIG. 8, the termination-side optical transmitter 108 includes a pre-emphasis circuit 121 for transmitting a signal by increasing the modulation degree based on the frequency characteristic, and uses the pre-emphasis circuit 121 to increase the modulation degree of the transmission signal and the reflective semiconductor optical amplifier 106 to conduct the modulation. Note that, the pre-emphasis circuit 121 can be realized by, for example, a filter having a desired characteristic or the frequency characteristic of the reflective semiconductor optical amplifier 106. Note that, the termination-side optical receiver 110 includes a termination-side light receiver 122 for receiving the light of the outgoing signal 109.

Further, the terminal station-side optical receiver 203 includes, for example, the reception band correction circuit 207 as illustrated in FIG. 6 in the same manner as in the first embodiment. However, unlike in the first embodiment, as shown in FIG. 7, the reception band correction circuit 207 corrects the reception band so as to correct the frequency characteristic subjected to the pre-emphasis by the termination-side optical transmitter 108 to become flat within the band. Note that, the configurations of the pre-emphasis circuit 121 of the termination-side optical transmitter 108 and the reception band correction circuit 207 of the terminal station-side optical receiver 203 are merely examples, and this embodiment is not limited to the above-mentioned configurations as long as the pre-emphasis processing and the correction of the reception band can be conducted as described above. Note that, the terminal station-side optical transmitter 201 includes a terminal station-side optical modulator 205 for generating a modulation signal.

According to this embodiment, it is possible to realize the optical wavelength multiplex communication system 100 or the like in which the S/N ratio of the signal light is improved.

### Third Embodiment

Next, a third embodiment of the present invention is described. Note that, descriptions of the same points as those of the first embodiment and the second embodiment are omitted below.

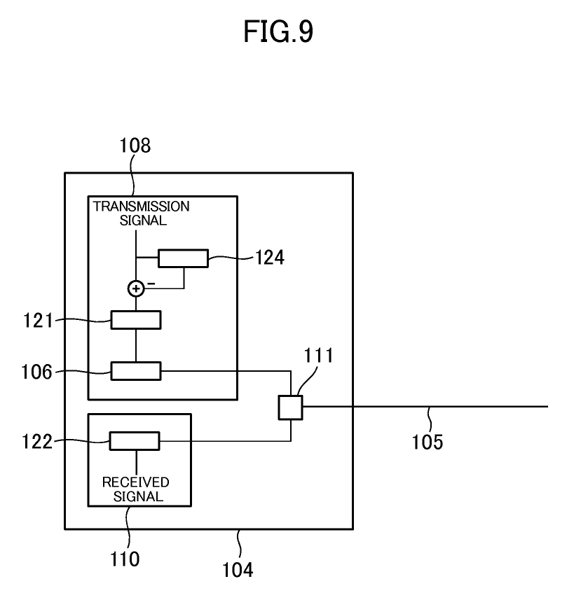

In this embodiment, as illustrated in FIG. 9, for example, the termination-side optical transmitter 108 according to the second embodiment further includes a delay attenuation circuit 124. The delay attenuation circuit 124 delays an electric signal for modulating the reflective semiconductor optical amplifier 106 based on a delay time of the signal light reflected and returned from the polarization rotation/reflection unit 115 with a polarity of the electric signal being inverted, and adds the resultant electric signal to the modulation signal in the reflective semiconductor optical amplifier 106 with a smaller amplitude than the original modulation signal. This can cancel an echo component of the delayed signal light returned to the reflective semiconductor optical amplifier 106. Note that, the delay time of the signal light that is reflected and returned is determined based on a fiber length from a reflection point. Further, this embodiment is not limited to the above-mentioned configuration as long as the configuration for canceling the echo component of the signal light is included as described above. Specifically, the case of providing the delay attenuation circuit 124 in addition to the pre-emphasis circuit 121 is described above, but the configuration including only the pre-emphasis circuit 121 may be employed.

According to this embodiment, it is possible to realize the optical wavelength multiplex communication system 100 or the like in which the S/N ratio of the signal light is improved. Further, according to this embodiment, it is possible to greatly suppress the deterioration in the S/N ratio of the signal light using the reflective semiconductor optical amplifier as the light source.

### Fourth Embodiment

Next, a fourth embodiment of the present invention is described. Note that, descriptions of the same points as those of the first embodiment to the third embodiment are omitted below.

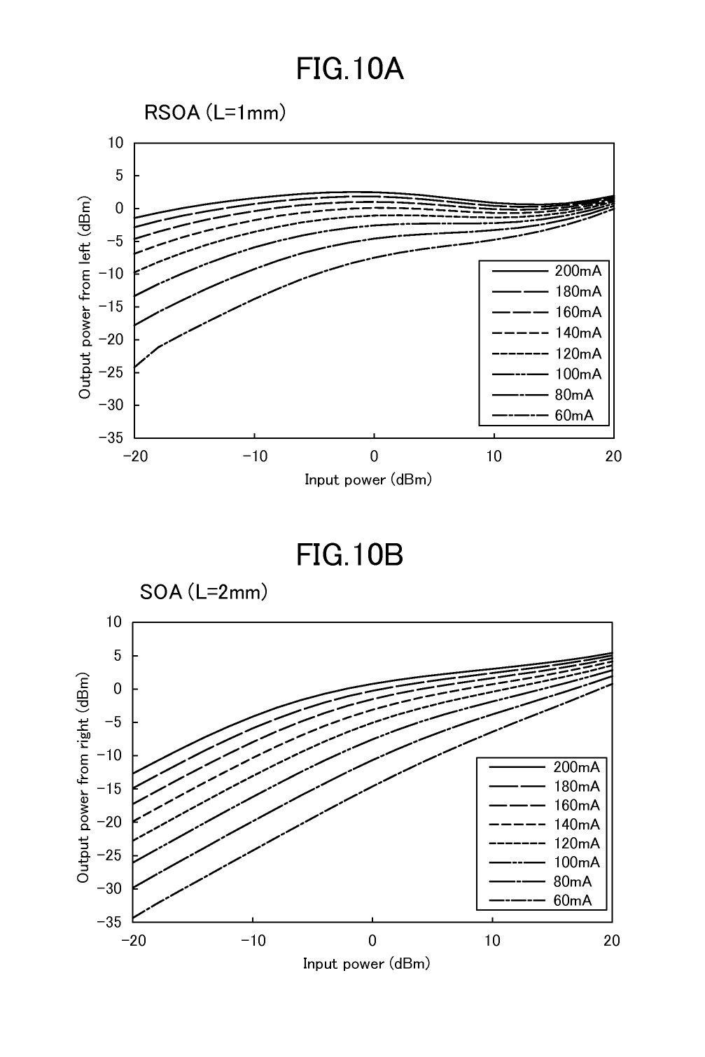

FIG. 10A is a graph for showing an input-output characteristic of the reflective semiconductor optical amplifier according to this embodiment. FIG. 10B is a graph for showing an input-output characteristic of a related-art semiconductor optical amplifier that is not a reflective type, as a comparative example.

As shown in FIG. 10B, the input-output characteristic of the related-art general transmissive semiconductor optical amplifier cannot achieve an output flattening effect no matter how long a length of an optical amplifier is set to be.

In contrast, as shown in FIG. 10A, the reflective semiconductor optical amplifier 106 according to this embodiment can achieve the output flattening effect by a cross-gain saturation effect that occurs in the reflective semiconductor optical amplifier 106 in a process of reflecting and amplifying light input from a first end face by a second end face. Note that, in the reflective semiconductor optical amplifier, an end face through which the output light from the reflective semiconductor optical amplifier 106 is emitted corresponds to the first end face (front end face), and an end face by which the input light is reflected corresponds to the second end face (back end face).

The reflective semiconductor optical amplifier 106 according to this embodiment modulates the signal light by using the range in which the output is flattened in this manner, that is, the MCDR capable of canceling the signal light returned from the polarization rotation/reflection unit 115. Accordingly, it is possible to build the optical wavelength multiplex communication system with more stability as the MCDR becomes wider. Note that, the reflective semiconductor optical amplifier according to this embodiment corresponds to, for example, the reflective semiconductor optical amplifier 106 according to any one of the first embodiment to the third embodiment.

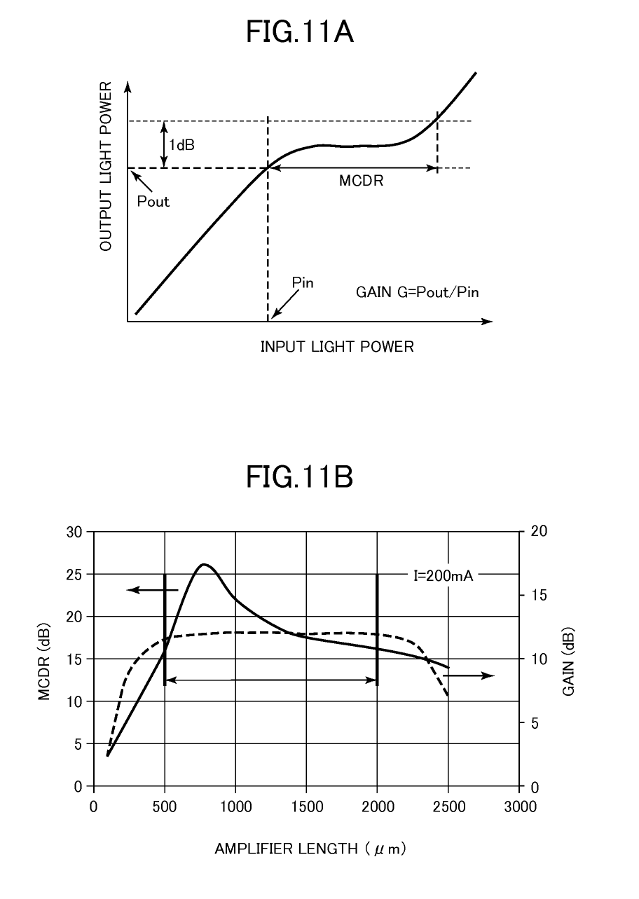

FIG. 11A is a graph for showing a relationship between input light power and output light power of the reflective semiconductor optical amplifier according to this embodiment. FIG. 11B is a graph for showing amplifier length dependency of the MCDR and a gain of the reflective semiconductor optical amplifier according to this embodiment. Note that, in FIG. 11B, as an example, a current injected into the reflective semiconductor optical amplifier 106 is 200 mA, and reflectances of the first end face and the second end face are nonreflectiveness (<0.1%) and high reflectance (95%), respectively.

As understood from FIG. 11B, the MCDR has a characteristic that changes depending on an amplifier length of the reflective semiconductor optical amplifier 106. This characteristic curve was first found by the inventors of the present invention through their intensive studies. The MCDR has a tendency to decrease as the amplifier length becomes shorter after peaking at an amplifier length of approximately 750 μm. In contrast, when the amplifier length becomes longer than 750 μm, the MCDR decreases steeply at first, and starts to decrease more gradually than in the case where the amplifier length becomes shorter. In addition, when the amplifier length is shorter than 500 μm or longer than 2,000 μm, the gain indicated by the dotted line starts to be attenuated and stops being constant, and hence transmission waveform quality of the modulated signal light deteriorates.

Therefore, in this embodiment, in view of those various characteristics of the reflective semiconductor optical amplifier, the length between the first end face and the second end face, that is, the amplifier length is set within a range of from 500 μm to 2,000 μm.

With this setting, it is possible to secure the MCDR sufficient for a stable operation equal to or larger than 15 dB in a state in which the gain is stabilized.

Note that, to build a more stable optical wavelength multiplex communication system, the MCDR thereof may be further increased. For example, the length of the amplifier is further limited to within a range of from 600 μm to 1,200 μm. With this setting, it is possible to secure the MCDR equal to or larger than 20 dB, which is practically sufficiently large.

In this case, even when the reflectances of the first end face and the second end face are changed, there is no large change in the amplifier length dependency of the gain and the MCDR shown in FIG. 11B. This implies that the amplifier length is dominant over the reflectance of an end face as a key parameter that predominates over the characteristics of a reflective amplifier.

Further, as the injected current is decreased below 200 mA, a range within which the gain stays constant decreases, and the MCDR also becomes narrower. In contrast, as the injected current is increased above 200 mA, the amplifier significantly causes heating with the characteristic starting to deteriorate, which is not preferred from the viewpoint of lower power consumption as well. Accordingly, in this embodiment, it is preferred to set the injected current to, for example, within a range of from 100 mA to 300 mA.

Specifically, for example, in this embodiment, in order to secure a wider MCDR in the state in which the gain of the reflective semiconductor optical amplifier 106 is stabilized, the amplifier length is set to 1,000 μm, and from the viewpoint of the characteristics of the gain and the MCDR and the lower power consumption, the currents injected into the amplifier at the “1 (on)” level and at the “0 (off)” level are set to 200 mA and 120 mA, respectively.

According to this embodiment, it is possible to secure a desired MCDR, and to realize the optical wavelength multiplex communication system capable of higher speed modulation. More specifically, for example, it is possible to secure a wide MCDR of the reflective semiconductor optical amplifier, and to realize the optical wavelength multiplex communication system or the like that conducts modulation stably at a transmission speed of 5 Gbps. Further, by combining this embodiment with the first embodiment to the third embodiment for use, it is also possible to realize the optical wavelength multiplex communication system with a further increased S/N ratio of the signal light.

### Fifth Embodiment

Next, a fifth embodiment of the present invention is described. Note that, descriptions of the same points as those of the first embodiment to the fourth embodiment are omitted below.

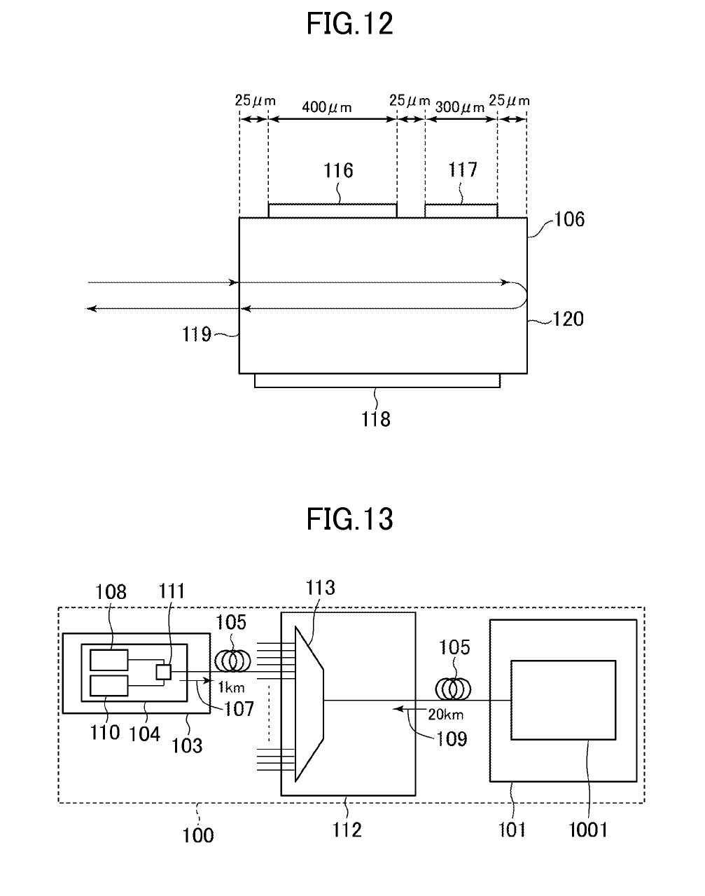

In this embodiment, as illustrated in FIG. 12, in the reflective semiconductor optical amplifier 106, a first electrode 116 and a second electrode 117 are provided to one surface substantially parallel with the signal light, and a back surface electrode 118 is provided to the other surface.

Specifically, for example, the first electrode 116 for conducting current injection in order to generate signal light optically amplified by a given specific channel and the second electrode 117 for modulating the signal light are formed to one surface of the reflective semiconductor optical amplifier 106 as described above. In this case, for example, the length of the first electrode 116 is set to approximately 400 μm, and the length of the second electrode 117 is set to approximately 300 μm. Further, for example, the amplifier length including the lengths of the first electrode 116 and the second electrode 117 is set to such a length as to substantially maximize the MCDR as shown in FIG. 11B. More specifically, for example, a reflective semiconductor amplifier length is set to 775 μm. Note that, the current at the “1 (on)” level of the transmission signal injected into the reflective semiconductor optical amplifier 106 is set to 200 mA, and the current at the “0 (off)” level is set to 120 mA. Note that, the reflective semiconductor amplifier length corresponds to a distance between an end face 119 (first end face) through which the output light to the reflective semiconductor optical amplifier 106 is emitted and an end face 120 (second end face) by which the input light is reflected.

As described above, in this embodiment, independent two electrodes are provided, and the length of the second electrode 117 for conducting the modulation is shortened. With this configuration, the signal light optically amplified by a given specific channel can be subjected to the higher speed modulation. The amplifier length for securing the MCDR and a high gain is substantially determined based on the distance between the first end face and the second end face, but a high speed operation characteristic depends on the length of the second electrode 117 for applying the modulated current. The shorter length of the second electrode 117 is more advantageous for a high speed operation. Therefore, according to this embodiment, it is possible to conduct the high speed operation while suppressing the influence on the MCDR and gain characteristics. Specifically, for example, it is possible to realize the reflective semiconductor optical amplifier 106 capable of realizing the modulation in which the transmission speed is increased from 5 Gbps to 10 Gbps.

Note that, the above-mentioned lengths and numbers of the first electrode 116 and the second electrode 117 are merely examples, and this embodiment is not limited to the above-mentioned configuration. For example, a first electrode and a second electrode may be formed for the current injection, and a third electrode may be formed for the current injection that aims at the high speed modulation.

Further, in this embodiment, a direct current is applied to the first electrode 116 on the first end face 119 side, and the modulation signal is applied to the second electrode 117 on the second end face 120 side. However, the modulation signal may be applied to the first electrode 116, and a direct current may be applied to the second electrode 117. In addition, in the above-mentioned embodiment, an electrode of reflective semiconductor optical amplifier 106 is divided into two electrodes so as to provide the area for applying the direct current and the area for applying the modulation signal, but the two areas may be provided separately. For example, a semiconductor amplifier having an optical amplification function may be provided at the previous stage when viewed from the side on which an incoming signal is emitted, and a reflective semiconductor optical amplifier optically connected to the semiconductor amplifier may be provided at the subsequent stage. In this case, it is preferred that a total length of the amplifier length of the effectively operated area of the semiconductor amplifier at the previous stage and the amplifier length of the reflective semiconductor optical amplifier at the subsequent stage be set to be the same as the optimum amplifier length of the reflective semiconductor optical amplifier 106 described above.

According to this embodiment, it is possible to realize the optical wavelength multiplex communication system that stably operates with the higher speed modulation. Further, by combining this embodiment with the first embodiment to the fourth embodiment for use, it is also possible to realize the optical wavelength multiplex communication system with a further increased S/N ratio of the signal light. More specifically, for example, it is possible to realize the optical wavelength multiplex communication system that stably operates with the high speed modulation at the transmission speed of 10 Gbps.

### Sixth Embodiment

Next, a sixth embodiment of the present invention is described. Note that, descriptions of the same points as those of the first embodiment to the fifth embodiment are omitted below.

FIG. 13 is a diagram for illustrating an outline of a configuration of an optical wavelength multiplex communication system according to a sixth embodiment of the present invention. In this embodiment, the optical branch coupler 114 and the polarization rotation/reflection unit 115 described in the first embodiment are provided within the terminal station 101 instead of within the remote node 112. Here, there is a case where an optical fiber or the like has already been laid between each home and a base station or the like. In this case, in order to apply the first to fifth embodiments, it is necessary to newly install an optical branch coupler and a polarization rotation/reflection unit midway through the connection by the optical fiber. However, according to this embodiment, by installing the optical branch coupler and the polarization rotation/reflection unit within the terminal station, it is possible to build the same communication system as those of the first embodiment to the fifth embodiment without adding any change to the optical fiber in the field.

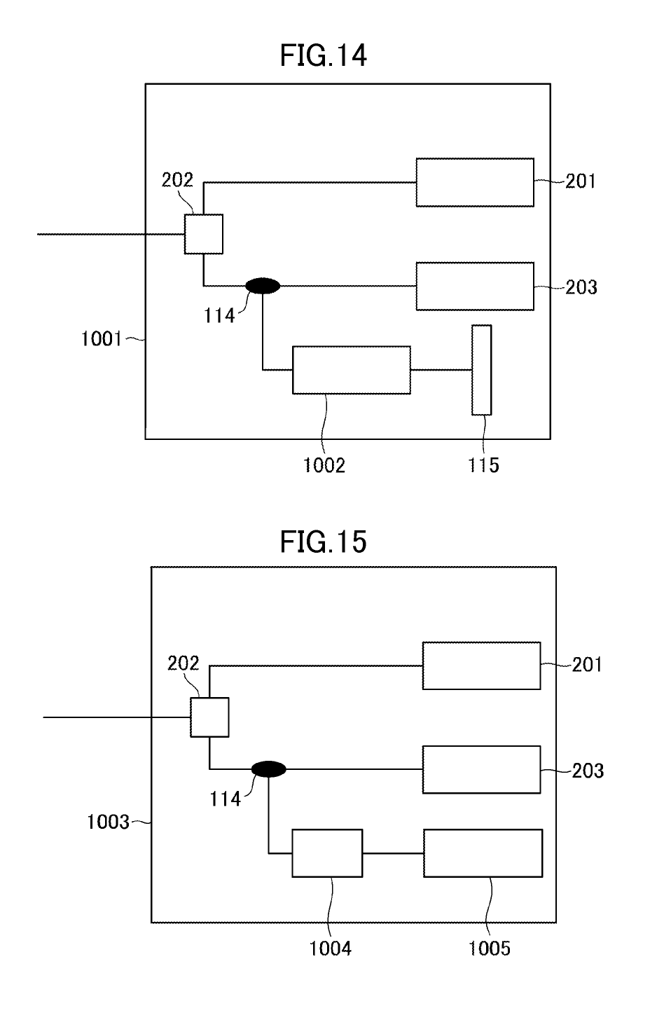

FIG. 14 is a diagram for illustrating an example of a configuration of a terminal station-side optical transceiver 1001 illustrated in FIG. 13. In this embodiment, for example, as illustrated in FIG. 14, unlike the terminal station-side optical transceiver 102 illustrated in FIG. 2, the optical branch coupler 114 is provided between the WDM filter 202 and the terminal station-side optical receiver 203, and an optical amplifier 1002 and the polarization rotation/reflection unit 115 are provided in a path after a branch. Further, as illustrated in FIG. 13, the optical branch coupler 114 or the polarization rotation/reflection unit 115 is not provided in a vicinity of the remote node 112.

The operation principle of this embodiment is the same as the principle described in the first embodiment, and the light emitted from the reflective semiconductor optical amplifier 106 is reflected by the polarization rotation/reflection unit 115 after passing through the optical fiber, and becomes a stable optical signal. The optical amplifier 1002 provided at the previous stage of the polarization rotation/reflection unit 115 is provided in order to compensate a loss of light intensity due to the optical fiber 105 or the like because a distance between the reflective semiconductor optical amplifier 106 and the polarization rotation/reflection unit 115 is longer than that of the first embodiment. More specifically, for example, the optical amplifier 1002 is formed of a semiconductor optical amplifier, and amplifies the light passing therethrough by applying a direct current to the semiconductor optical amplifier. Note that, the optical amplifier 1002 does not need to be the semiconductor optical amplifier as long as the amplification of the light intensity is obtained, and may be a fiber amplifier or the like. However, it is preferred to use the semiconductor optical amplifier from the viewpoint of the downsizing and the lower power consumption of the terminal station-side optical transceiver 1001.

Note that, this embodiment may be configured as such a modification example as described below. FIG. 15 is a diagram for illustrating an outline of a configuration of a terminal station-side optical transceiver 1003 according to a modification example of the sixth embodiment. A different point from the terminal station-side optical transceiver 1001 is the configuration of the optical branch coupler 114 and the components connected after branching thereafter. In this modification example, a polarization rotator 1004 and a reflective semiconductor optical amplifier 1005 are used in place of the optical amplifier 1002 and the polarization rotation/reflection unit 115. An operation principle of this modification example is basically the same as the above-mentioned principle, and the reflective semiconductor optical amplifier 1005 has both functions of amplification of the loss of the light intensity and light reflection with respect to the reflective semiconductor optical amplifier 106 connected on the termination side. Note that, the polarization rotator 1004 provided at the previous stage may be provided as necessary, and becomes unnecessary when polarization dependency of the reflective semiconductor optical amplifier 106 is small (to a degree that does not influence the communication system).

According to this embodiment, it is possible to realize the optical wavelength multiplex communication system that stably operates with the higher speed modulation. Further, by combining this embodiment with the first embodiment to the fifth embodiment, it is also possible to realize the optical wavelength multiplex communication system with a further improved S/N ratio of the signal light. More specifically, for example, it is possible to realize the optical wavelength multiplex communication system that stably operates with the high speed modulation at the transmission speed of 10 Gbps.

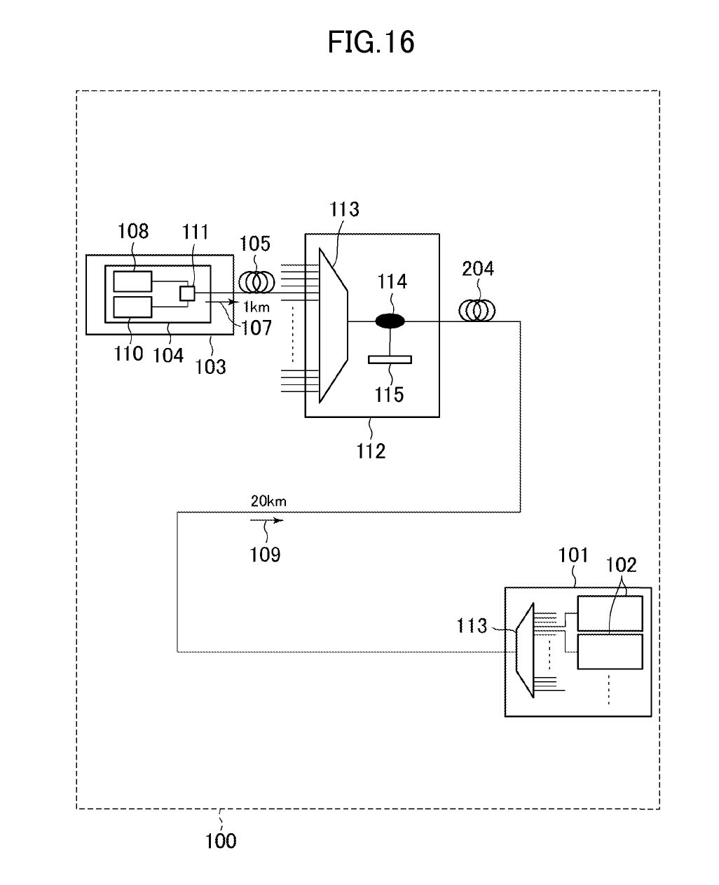

The present invention is not limited to the first embodiment to the sixth embodiment, and various modifications can be made. For example, the configuration described in each of the above-mentioned embodiments can be replaced by substantially the same configuration, the configuration that produces the same action and effect, or the configuration that achieves the same object. Specifically, for example, as illustrated in FIG. 16, the optical wavelength multiplex communication system 100 may be configured so that a plurality of terminal station-side optical transceivers 102 are arranged in the terminal station 101 with a plurality of stations as the termination devices 103. In this case, for example, the terminal station-side optical transceiver 102 different in the wavelength corresponding to wavelength multiplexing transmission is added for each channel within one terminal station 101. Further, the first embodiment to the sixth embodiment may be combined unless there is no contradiction therebetween. For example, the fourth embodiment or the fifth embodiment may be combined with the first embodiment to the third embodiment. Note that, a communication system of the appended claims corresponds to, for example, the optical wavelength multiplex communication system 100, and a reflective unit of the appended claims corresponds to, for example, the polarization rotation/reflection unit 115.

Further, in the above-mentioned embodiments, the expressions “termination” and “terminal station” are used for the sake of convenience of description, but the present invention may be applied to any optical communications between two points (two places).

While there have been described what are at present considered to be certain embodiments of the invention, it will be understood that various modifications may be made thereto, and it is intended that the appended claims cover all such modifications as fall within the true spirit and scope of the invention.

What is claimed is:

1. A communication system, comprising:
a termination-side optical transmitter comprising a reflective semiconductor optical amplifier;
a reflective unit configured to reflect output light from the termination-side optical transmitter; and
a terminal station-side optical receiver connected to the termination-side optical transmitter via a transmission line and configured to receive the output light from the termination-side optical transmitter by limiting a frequency band of the output light,
wherein the reflective semiconductor optical amplifier amplifies the output light reflected by the reflective unit, modulates the amplified output light based on an electric signal, and outputs the modulated output light.

2. The communication system according to claim 1, wherein the terminal station-side optical receiver receives the output light from the termination-side optical transmitter by limiting the frequency band of the output light based on a frequency characteristic of a relative intensity noise of the output light.

3. A communication system, comprising:
a termination-side optical transmitter comprising a reflective semiconductor optical amplifier and a pre-emphasis unit configured to increase a modulation degree of a transmission signal;
a reflective unit configured to reflect output light from the termination-side optical transmitter; and
a terminal station-side optical receiver connected to the termination-side optical transmitter via a transmission line,
wherein the reflective semiconductor optical amplifier amplifies the output light reflected by the reflective unit, modulates the amplified output light based on an electric signal having the increased modulation degree, and outputs the modulated output light.

4. The communication system according to claim 3, wherein the pre-emphasis unit increases the modulation degree based on a frequency characteristic of a relative intensity noise of the output light.

5. The communication system according to claim 4, wherein the terminal station-side optical receiver receives the output light from the termination-side optical transmitter by limiting a frequency band of the output light.

6. The communication system according to claim 5, wherein the terminal station-side optical receiver receives the output light from the termination-side optical transmitter by limiting the frequency band of the output light based on an increase in the modulation degree caused by the pre-emphasis unit.

7. The communication system according to claim 3, wherein the pre-emphasis unit increases the modulation degree within a modulation frequency range up to approximately ½ of a transmission rate.

8. A communication system, comprising:
a termination-side optical transmitter comprising a reflective semiconductor optical amplifier;
a reflective unit configured to reflect output light from the termination-side optical transmitter; and
a terminal station-side optical receiver connected to the termination-side optical transmitter via a transmission line and configured to receive the output light from the termination-side optical transmitter,
wherein the reflective semiconductor optical amplifier amplifies the output light reflected by the reflective unit, modulates the amplified output light based on an electric signal, and outputs the modulated output light, and
wherein an amplifier length of the reflective semiconductor optical amplifier is from 500 pm to 2,000 μm.

9. The communication system according to claim 8, wherein a current injected into the reflective semiconductor optical amplifier is from 100 mA to 300 mA.

10. The communication system according to claim 9, wherein:
the reflective semiconductor optical amplifier comprises a first electrode and a second electrode; and
the first electrode and the second electrode are different from each other in length, and are configured to inject the current independently.

11. The communication system according to claim 10, wherein:
the length of the second electrode in a direction along the output light is shorter than the length of the first electrode; and
the current for modulating the output light based on the electric signal is injected into the second electrode.

12. The communication system according to claim 3, wherein:
the termination-side optical transmitter further comprises a delay attenuation unit configured to delay the electric signal based on a delay time of the output light returned to the reflective semiconductor optical amplifier after being reflected by the reflective unit and configured to invert a polarity of the electric signal; and
the reflective semiconductor optical amplifier further modulates the output light based on a signal output from the delay attenuation unit, and outputs the modulated output light.

13. The communication system according to claim 3, further comprising a plurality of termination devices each comprising the termination-side optical transmitter,
wherein the respective termination-side optical transmitters comprised in the plurality of termination devices are different from one another in wavelength of the output light.

14. The communication system according to claim 3, further comprising a terminal station comprising:
a plurality of the terminal station-side optical receivers; and
a plurality of terminal station-side optical transmitters,
wherein the plurality of terminal station-side optical transmitters respectively output the output light having different wavelengths from one another.

15. An optical transceiver, comprising:
the termination-side optical transmitter of claim 3; and
a termination-side optical receiver.

16. An optical transceiver, comprising:
the terminal station-side optical receiver of claim 3; and
a terminal station-side optical transmitter.

17. The optical transceiver according to claim 16, the reflective unit is comprised in the optical transceiver.

18. The optical transceiver according to claim 17, wherein the reflective unit within the optical transceiver comprises an optical amplifier and a polarization rotation/reflection unit.

19. The optical transceiver according to claim 17, wherein the reflective unit within the optical transceiver comprises a reflective semiconductor optical amplifier.
